(19) United States
(12) Patent Application Publication
(10) Pub. No.: US 2014/0291405 A1
(43) Pub. Date: Oct. 2, 2014

(54) REUSABLE ELECTRONIC BAG TAG

(71) Applicant: Erik Jan Harkes, Warmond (NL)

(72) Inventor: Erik Jan Harkes, Warmond (NL)

(73) Assignee: EC Solution Group B.V. a corporation, Warmond (NL)

(21) Appl. No.: 14/116,009

(22) PCT Filed: May 7, 2012
(86) PCT No.: PCT/EP2012/058352

§ 371 Date: Apr. 17, 2014

(30) Foreign Application Priority Data
May 6, 2011 (GB) 1107559.5

(51) Int. Cl. G06K 19/077; G06K 19/07

(52) U.S. Cl. CPC G06K 19/07707; G06K 19/0723; G06K 19/07749
USPC 235/492

(57) ABSTRACT

The invention provides a dual-display reusable electronic bag tag that can wirelessly receive bag tag data via RFID (HF) or via other wireless means, that is backward compatible with visual bag tag data and barcode in-line-of-sight scanning and tracking technology, that is compatible with track & tracing technology and that is adaptive to fit other (emerging) wireless communication technology regardless of whether nor not this requires a local power supply. The invention further provides a suitcase with an integrated electronic bag tag.

### CROSS-REFERENCE TO RELATED APPLICATION

The present application is a national stage filing of International patent application Serial No. PCT/EP2012/058352, filed May 7, 2012, and published as WO 2012/152745 A1 in English.

### FIELD OF THE INVENTION

The present invention relates to bag tags. More specifically the invention relates to reusable bag tags.

### BACKGROUND

The discussion below is merely provided for general background information and is not intended to be used as an aid in determining the scope of the claimed subject matter.

Bag tags, also known as baggage tags, baggage checks or luggage tickets, have traditionally been used by bus, train and airline companies to route passenger luggage that is checked on to the final destination.

Prior to the 1990s, airline bag tags consisted of a paper tag attached with a string. The tag contained basic information that was written or printed on the paper tag, namely the airline/carrier name, flight number, a 5, 6 or 10 digit code and the name of the airport of arrival. These tags became obsolete as they offered little security and were easy to replicate.

Current bag tags include a bar code. These bag tags are printed using thermal or barcode printers that print on an adhesive paper stock. This printed strip is then attached to the luggage at check in. This allows for automated sorting of the bags to reduce the number of misrouted, misplaced or delayed bags. Automated sorting of baggage using laser scanner arrays, known as automatic tag readers, to read bar-coded bag tags is standard at major airports.

For flights within the European Union, bag tags are issued with green edges. Passengers are eligible to take these bags through a separate “Blue Channel” at Customs.

Bar codes cannot be automatically scanned without direct sight and undamaged print. Forced by reading problems with poorly-printed, obscured, crumpled, scored or otherwise damaged bar codes, some airlines have started using radio-frequency identification (RFID) chips embedded in the existing tags. E.g. in the US, McCarran International Airport installed an RFID system throughout the airport. Hong Kong International Airport has also installed an RFID system. The International Air Transport Association (IATA) is trying to standardize RFID bag tags. There is a somewhat higher probability of reading RFID tags automatically. Physically, however, RFID tags are not more robust than barcode tags.

The term license plate is the official term used by the IATA, the airlines, and the airports for the 10-digit numeric code on a bag tag issued by a carrier or handling agent at check-in. The license plate is printed on the carrier tag in bar code form and in human-readable form, as defined in Resolution 740 in the IATA Passenger Services Conference Resolutions Manual (published annually by IATA). Each digit in a license plate has a specific meaning. The license plate is an index number linking a bag to a Baggage Sortation Message (BSM) sent by a carrier's departure control system to an airport's baggage handling system. It is the message that contains the flight details and passenger information, thus enabling an automated baggage handling system to sort a bag automatically once it has scanned the bar code on the carrier tag.

Besides the license plate number, the current bag tags also contain the name of airport of arrival, departure time, IATA airport code of airport of arrival, airline code and flight number and the name of the passenger identified with the baggage (last name, first name).

More than 1% of all baggage worldwide gets lost or mishandled each year. The cost to rectify this comes down to [symbol] 70 per bag, plus the airline may loose passengers to another competitor airline. This is a major problem that the industry is looking to solve. Most baggage sortation and processing systems at airports worldwide are based on visual bag tag data and 1D barcodes printed on paper bag tags. The barcode scanners have to be “in line of sight” in order to be able to “read” the 1D barcodes and get them on the right “track” for it to be loaded on the correct baggage carts or ULD (Unit Loading Device) and onto the correct aircraft.

An important reason why baggage gets lost is that the barcode on the bag tag is badly readable, e.g. due to low toner printing or tears or folds in the bag tag. Implementing RFID technology and printed paper bag tags with an RFID (UHF) tag inside and/or permanent RFID (UHF) bag tags could reduce the baggage loss, however the adoption of RFID has proven very slow due to high implementation costs, at least 80 of the larger airports in the world being required to start reaping the benefits of RFID, RFID tags only solving 10% to 20% of all lost baggage depending on type of tag, no business case being available or hard to make, permanent RFID (UHF) tags being unsuitable for displaying bag tag information or barcodes, permanent RFID (UHF) tags having very limited applicability as the “receiving” airport needs to be equipped with RFID devices and airports do not change overnight to RFID, and printed paper bag tags with or without RFID tag being a financial and environmental waste due to its single use.

When travelling by air, hold baggage has to be checked. This is done today at the airport using manned (staffed) check-in or dedicated baggage check-in counters. Implementing an automated, unmanned, baggage check-in process can make tremendous cost savings and a faster automated process will also increase the throughput per m² at an airport, improve the flow at an airport and postpone airport expansion with ever increasing total number of passengers per year.

Pilots with automated unmanned baggage check-in counters are known. Less staff is found to be required, but the process is slow as passengers have to label their bags themselves, which is something they are not used to do. In fact, on average the automated baggage check-in process takes longer than the traditional manned baggage check-in (1 min 5 sec versus little under 1 min).

There is a need for a solution that not only provides a fast way of processing, like RFID HF (not RFID UHF), but also eliminates the baggage-labeling process. Ideally such solution would be backward compatible with existing visual bag tag readers.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the background. An aspect of the invention provides a dual-display reusable electronic bag tag that can wirelessly receive bag tag data via RFID (HF) or via other wireless means, that is backward compatible with visual bag tag data and barcode in-line-of-sight scanning and tracking technology, that is compatible with track & tracing technology and that is adaptive to fit other (emerging) wireless communication technology regardless of whether nor not this requires a local power supply.

According to an aspect of the invention an electronic bag tag is proposed that is configured to display bag tag data received from a first external source. The electronic bag tag comprises miniaturized electronics. The miniaturized electronics comprises a processor configured to process the bag tag data to obtain processed bag tag data. The miniaturized electronics further comprises a wireless communication interface that is communicatively connected to the processor. The wireless communication interface is configured to receive the bag tag data from the first external source. The miniaturized electronics further comprises a non-volatile memory that is communicatively connected to the processor. The non-volatile memory is configured to store the bag tag data and/or processed bag tag data. The miniaturized electronics further comprises a first display and a second display. Each of the first display and the second display is configured to display at least a part of the processed bag tag data. The non-volatile memory is preconfigured with one or more templates. The processor is configured to select a template from the one or more templates for displaying the at least part of the processed bag tag data on at least one of the first display and the second display using the template.

The electronic bag tag may also be called a smart tag or a smart label.

The processor and non-volatile memory can be integrated in a single integrated circuit, possibly together with further components.

The bag tag data as received in the electronic bag tag is processed to make it suitable for displaying on the first and second display. It is possible that the tag data or parts of the tag data can be displayed without processing, in which case the processor simply processes the tag data by storing it in the non-volatile memory.

For backward compatibility purposes the use of embedded active matrix displays is preferred and would be most cost effective given the amount of data and barcodes that need to be displayed on the displays. However the electronic bag tag's system architecture can accommodate other types of displays such as segmented displays and passive matrix displays or a combination of display types.

The first display and second display typically have identical outputs, but it is possible that the two displays output different parts of the processed bag tag data.

By using and integrating two, thin, flexible or inflexible displays in a programmable flexible or inflexible tag, the electronic bag tag can advantageously be made to display all bag tag data including e.g. horizontally and vertically positioned 1D barcodes on two sides of the bag tag in conformance with IATA specifications as described in the IATA Baggage Services Manual, making it backward compatible with visual bag tag data and barcode in-line-of-sight scanning technology as used at airports worldwide. The electronic bag tag can advantageously be integrated with e.g. a RFID UHF assembly to make it compatible with the scanning and tracking & tracing technology as used in some airports. Advantageously, the electronic bag tag is reprogrammable and can be wirelessly updated eliminating the baggage labeling process and making the bag tag reusable.

The predefined templates stored within the electronic bag tag may advantageously be used for formatting the output on the displays. This avoids having to transmit the layout information to the electronic bag tag.

The embodiment of claim 2 advantageously enables the electronic bag tag to be battery-less.

The embodiment of claim 3 advantageously enables the electronic bag tag to be read by external RFID readers in addition to visual bag tag data and barcode in-line-of-sight scanners.

The first, second and/or third external sources can be one and the same.

The embodiment of claim 4 advantageously enables components that typically cannot be powered by power inducted by a RF field alone, to be used in the electronic bag tag. Non-limiting examples of such components are components providing GPS, GNSS hybrid, mobile telecommunication such as GSM, GPRS, UMTS, LTE, CDMA or CDMA2000, other wireless communication such as DASH7, Bluetooth Low Energy or Zigbee, LED light and MEMS sensors.

The embodiment of claim 5 advantageously enables the electronic bag tag to be provided with bag tag data over relatively long distance compared to short distance RFID technology. Furthermore it enables the electronic bag tag to be traced or located.

The embodiment of claim 6 advantageously enables the two displays to be controlled by a single display controller or two separately integrated display controllers, thereby minimizing component space. Moreover, the dual display controller can advantageously be embedded in an integrated circuit together with the processor and the non-volatile memory, thereby reducing the number of components, reducing the complexity of the electronics and further minimizing component space.

The embodiment of claim 7 advantageously enables the electronic bag tag to have a form factor similar to that of a card, preferably credit card sized.

The embodiment of claim 8 advantageously enables the electronic bag tag to be foldable around e.g. the handle of a suitcase or a part of a buggy.

The embodiment of claim 9 advantageously enables the electronic bag tag to be integrated in luggage, e.g. in two sides of a suitcase.

The embodiments of claims 10 and 11 advantageously enable the electronic bag tag to have different form factors. Inflexible bag tags can be made very robust (thicker than flexible versions) and produced today using existing components and manufacturing facilities. Flexible bag tags may be preferred as the display and other internal components are less prone to breaking or for storing the bag tag (thinner and lighter than the inflexible versions) like a credit card in a wallet when not used.

The embodiment of claim 12 advantageously enables sensor data to be used e.g. to detect that the electronic bag tag is inside an airplane and disable the wireless communication interface while inside the airplane.

The embodiment of claim 13 advantageously enables backward compatibility and compliance with existing visual barcode in-line-of-sight scanners.

The embodiment of claim 14 advantageously enables only limited amounts of data, i.e. only the license plate number e.g. coded in ASCII instead of a graphical bitmap of the bar code corresponding to the license plate number, to be received in the electronic bag tag, from which the processor generates the graphical bitmap of the barcode to be displayed.

The embodiment of claim 15 advantageously enables each display to have two small green bars printed on top of the display's left and right side using e.g. green transparent ink to indicate a so-called “Schengen” baggage label conform the IATA specifications, which can be switched to black by e.g. positioning black pixels exactly behind the green bars in order to indicate a regular baggage label.

The embodiment of claim 17 advantageously enables the electronic bag tag to be used only by its true owner as identified by the external smart card, e.g. by a fingerprint reader on the external smart card. This can be used e.g. to check and safeguard the owner of the luggage to which the electronic bag tag is attached during check-in/drop-of.

According to another aspect of the invention is a method for using an electronic bag tag having a processor configured to process bag tag data, a wireless communication interface communicatively connected to the processor and configured to receive bag tag data from a first external source, a first display and a second display, the method includes: receiving bag tag data with the wireless communication interface; processing the bag tag data with the processor to obtain processed bag tag data, the processor further selecting a template from one or more templates for displaying at least part of the processed bag tag data; displaying the at least some of the processed bag tag data with the template on the first display and on the second display; and scanning at least one of the first display and the second display with an external scanner.

Thus, the electronic bag tag can be used with the above-mentioned advantages.

The embodiment of claim 19 advantageously enables the electronic bag tag to be traced or located.

According to another aspect of the invention a suitcase is proposed. The suitcase comprises the electronic bag tag according to claim 9. The first display is visibly attached on a first outer side of the suitcase. The second display is visibly attached on a second outer side of the suitcase opposite of the first outer side.

The suitcase makes use of the electronic bag tag with the above-mentioned advantages.

The embodiment of claim 21 advantageously enables the electronic bag tag to be embedded in the suitcase, preventing it from being ripped of the suitcase.

The embodiment of claim 22 advantageously enables the displays and possibly the electronics to be detached for maintenance or replacement.

The embodiment of claim 23 advantageously enables a power supply external to the electronic bag tag to be used for powering the electronic bag tag.

The embodiment of claim 24 advantageously enables the electronics to be moved to the power supply to thereby minimize the dimensions of the first part of the electronic bag tag with the first display and the second part of the electronic bag tag with the second display.

Hereinafter, embodiments of the invention will be described in further detail. It should be appreciated, however, that these embodiments may not be construed as limiting the scope of protection for the present invention.

### BRIEF DESCRIPTION OF THE DRAWINGS

Aspects of the invention will be explained in greater detail by reference to exemplary embodiments of the invention shown in the drawings, in which:

FIG. 1a shows the front side of an inflexible electronic bag tag of an exemplary embodiment of the invention;

FIG. 1b shows a perspective view of the backside of an inflexible electronic bag tag of an exemplary embodiment of the invention;

FIG. 2a shows the front side of a flexible electronic bag tag of an exemplary embodiment of the invention;

FIG. 2b shows a perspective view of the backside of a flexible electronic bag tag of an exemplary embodiment of the invention;

FIG. 3a shows a foldable and flexible electronic bag tag of an exemplary embodiment of the invention;

FIG. 3b shows a perspective view of a foldable and flexible electronic bag tag of an exemplary embodiment of the invention;

FIG. 4a shows an electronic bag tag of an exemplary embodiment of the invention that is suitable for integration in a suitcase;

FIG. 4b shows an electronic bag tag of another exemplary embodiment of the invention that is suitable for integration in a suitcase;

FIG. 4c shows an electronic bag tag of another exemplary embodiment of the invention that is suitable for integration in a suitcase;

FIG. 5 shows a suitcase with an electronic bag tag of an exemplary embodiment of the invention;

FIG. 6 shows a side-view of a suitcase with an electronic bag tag of an exemplary embodiment of the invention;

FIG. 7 shows a side-view of a suitcase with an electronic bag tag of an exemplary embodiment of the invention;

FIG. 8 shows a perspective view of the layers build-up of an inflexible electronic bag tag of an exemplary embodiment of the invention;

FIG. 9 shows a perspective view of the layers build-up of a flexible electronic bag tag of an exemplary embodiment of the invention;

FIG. 10 shows the components in the printed circuit board layer of an inflexible electronic bag tag of an exemplary embodiment of the invention;

FIG. 11 shows the components in the printed circuit board layer of a flexible electronic bag tag of an exemplary embodiment of the invention; and

FIG. 12a and FIG. 12b show templates displayed on an electronic bag tag of an exemplary embodiment of the invention.

### DETAILED DESCRIPTION OF THE DRAWINGS

The electronic bag tag of the invention is an integral, one-piece flexible or one-piece inflexible, non-disposable, (re-) programmable, passive (without battery/local power supply) or active (with battery/local power supply), reusable, “permanent” electronic bag tag. Miniaturized electronics in the bag tag are embedded in a printed circuit board (PCB) layer with a highly adaptive system architecture. Depending on the configuration the miniaturized electronics comprise e.g. an embedded RFID/UHF and RFID/HF wireless communication interface, embedded power management module, embedded main controller integrated circuit including a microprocessor and non-volatile memory, embedded electronic circuitry, two embedded displays made such that when strapped on the handle of a suitcase or bag one display is facing forward and the other display is facing the opposite way, an embedded display driver integrated circuit, and/or other optional embedded wireless communication interfaces.

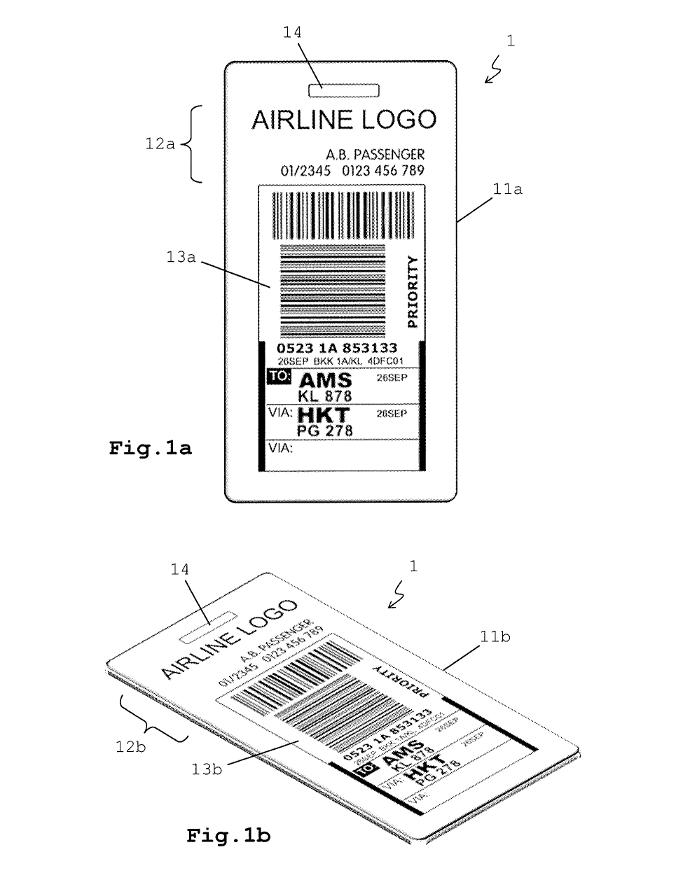

FIG. 1a and FIG. 1b show a front side (FIG. 1a) and back side (FIG. 1b) of an inflexible electronic bag tag 1 of an exemplary embodiment of the invention. The electronic bag tag 1 has wireless communication capabilities and an embedded display 13a, 13b on both the front side 11a and the rear side 11b of the tag 1. The front side 11a and backside 11b can be identical from a construction point of view, however the content on the displays 13a, 13b may differ.

The displays 13a and 13b are typically used to display variable information such as e.g. the license plate number, the name of the airport of arrival, flight date, IATA airport code of the airport of arrival, the airline code and/or flight number.

An information area 12a, 12b next to the display 13a, 13b can be used to print non-variable information, such as e.g. the name of the passenger (i.e. the owner of the electronic bag tag), a barcode with the name of the passenger and/or an identification code of the electronic bag tag encoded therein, advertorial information e.g. in the form of an airline logo, and etcetera. Alternatively or additionally the non-variable information can be displayed on the displays 13a and 13b.

The electronic bag tag 1 can have one or more punched or drilled holes 14 for attaching a baggage strap.

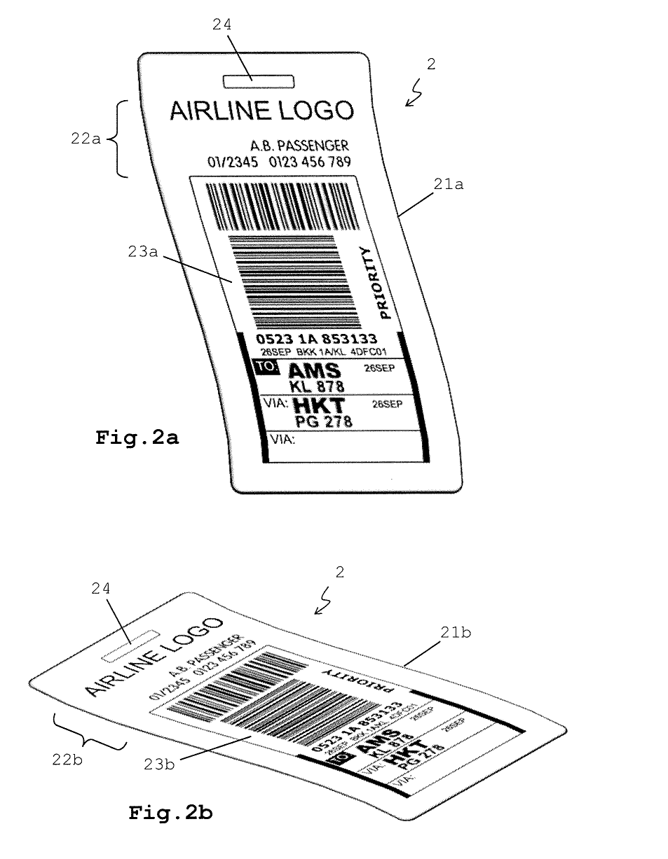

FIG. 2a and FIG. 2b show a front side (FIG. 2a) and back side (FIG. 2b) of a flexible electronic bag tag 2 of an exemplary embodiment of the invention. The electronic bag tag 2 has wireless communication capabilities and an embedded flexible display 23a, 23b on both the front side 21a and the rear side 21b of the tag 2. The front side 21a and backside 21b can be identical from a construction point of view, however the content on the displays 23a, 23b may differ.

The displays 23a and 23b are typically used to display variable information such as e.g. the license plate number, place and date of issue, the final destination name, the final destination and/or transfer routing in IATA airport code, the airline code and/or flight number.

An information area 22a, 22b next to the display 23a, 23b can be used to print non-variable information, such as e.g. the name of the passenger (i.e. the owner of the electronic bag tag), a barcode with the name of the passenger and/or an identification code of the electronic bag tag encoded therein, advertorial information e.g. in the form of an airline logo, and etcetera. Alternatively or additionally the non-variable information can be displayed on the displays 23a and 23b.

The electronic bag tag 2 can have one or more punched or drilled holes 24 for attaching a baggage strap.

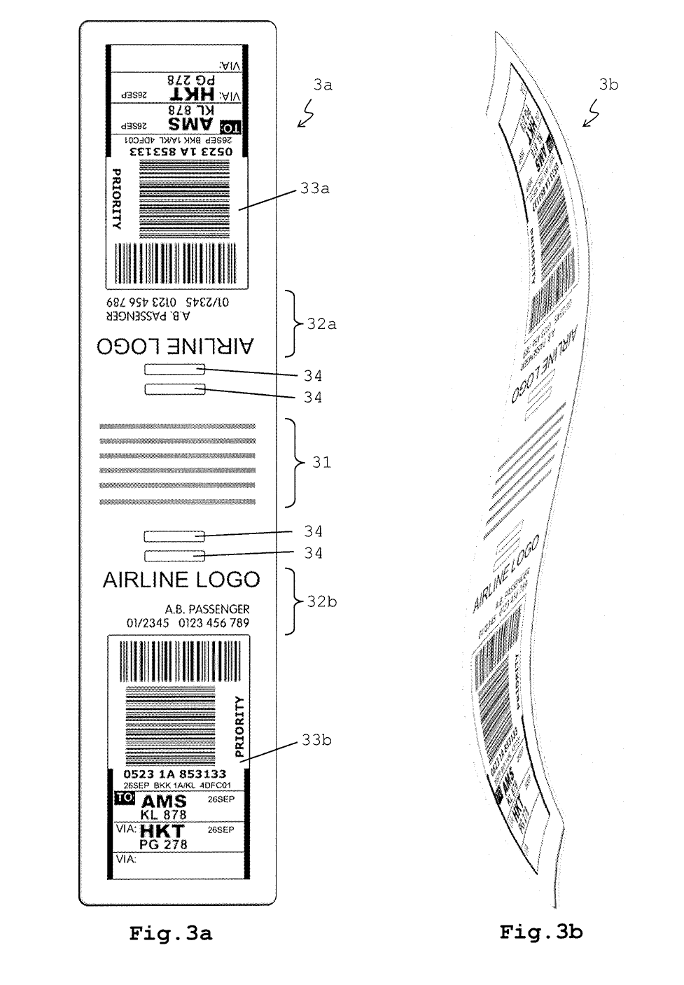

FIG. 3a and FIG. 3b show one side of a foldable electronic bag tag 3, 3b of an exemplary embodiment of the invention. FIG. 3a shows an inflexible foldable electronic bag tag 3a. FIG. 3b shows a foldable electronic bag tag 3b. The backside, which is not shown, can be blank or printed with any information. The electronic bag tag 3 has wireless communication capabilities and two embedded displays 33a, 33b. The content on the displays 33a, 33b may differ. The electronic bag tag 3 is foldable at a folding area 31 such that the first display 33a and the second display 33b are facing opposite directions when the bag tag is folded.

The displays 33a and 33b are typically used to display variable information such as e.g. the license plate number, place and date of issue, the final destination name, the final destination and/or transfer routing in IATA airport code, the airline code and/or flight number.

A space 32a, 32b next to the display 33a, 33b can be used to print non-variable information, such as e.g. the name of the passenger (i.e. the owner of the electronic bag tag), a barcode with the name of the passenger and/or an identification code of the electronic bag tag encoded therein, advertorial information e.g. in the form of an airline logo, and etcetera. Alternatively or additionally the non-variable information can be displayed on the displays 33a and 33b.

The electronic bag tag 3a, 3b can have one or more punched or drilled holes 34 for attaching a baggage strap.

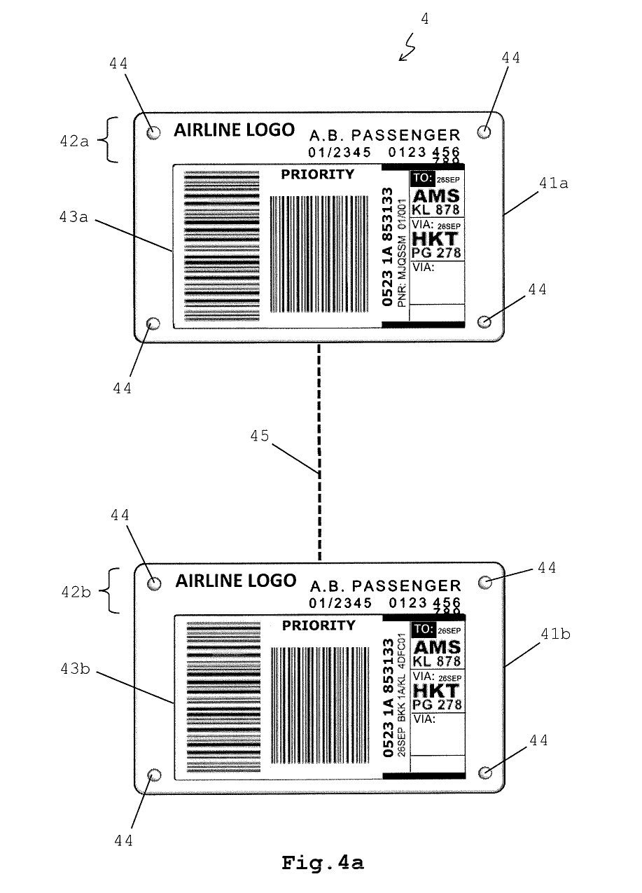

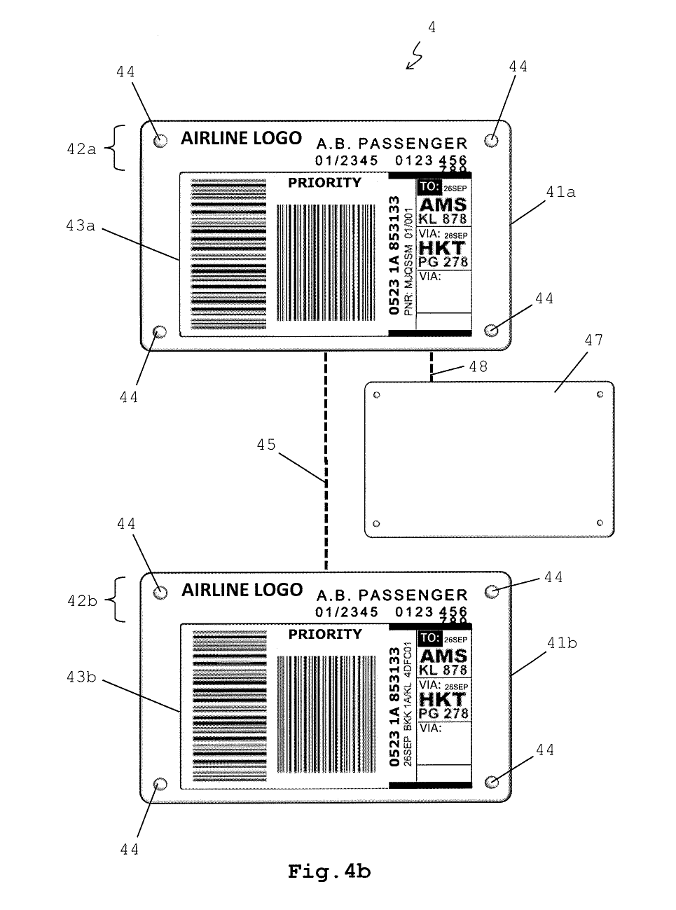

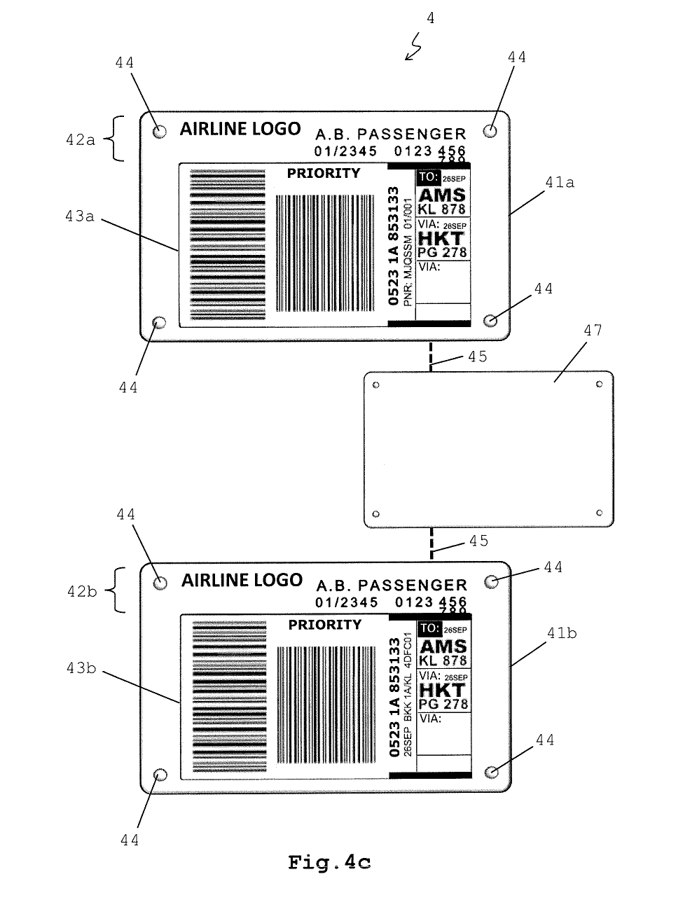

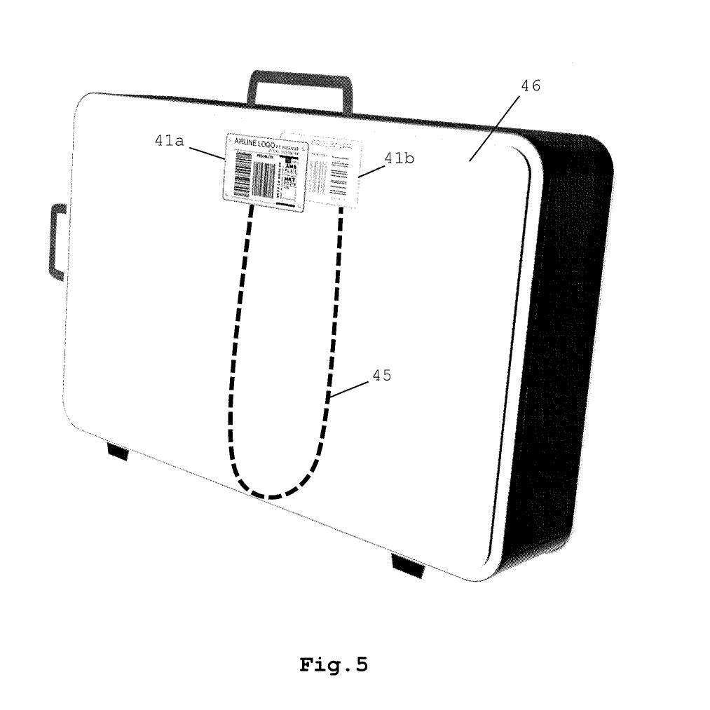

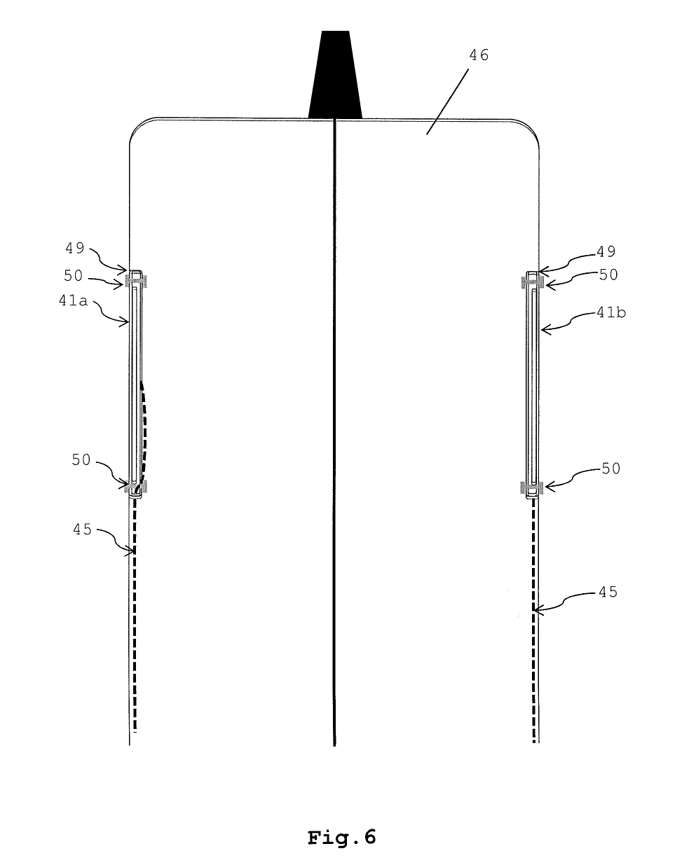

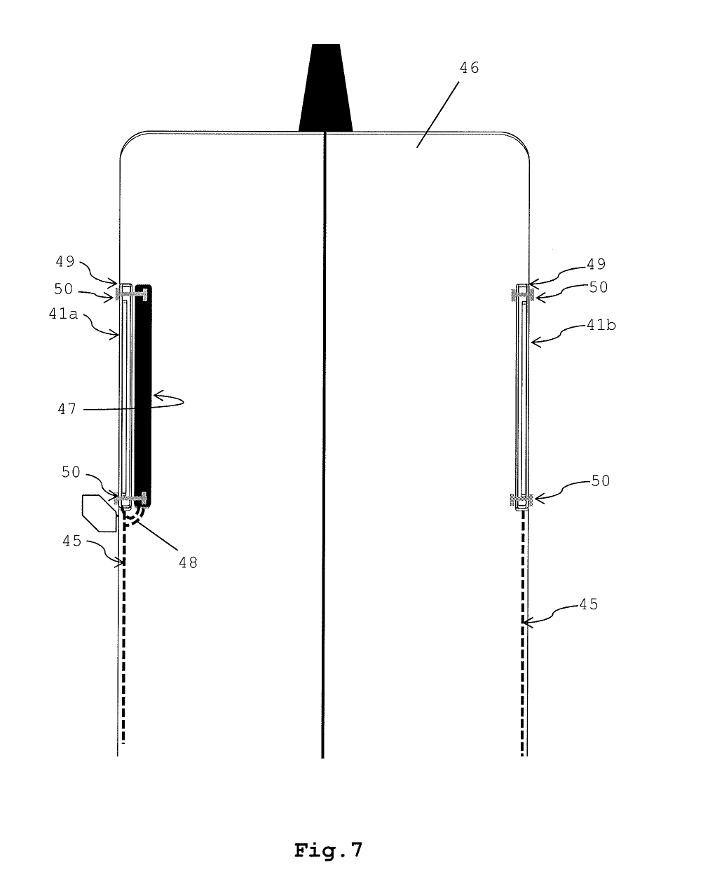

FIGS. 4a-4c show an electronic bag tag 4 of exemplary embodiments of the invention that are particularly suitable to be integrated in a suitcase 46 as shown in FIG. 5, FIG. 6 and FIG. 7. The electronic bag tag 4 has wireless communication capabilities and an embedded display 43a, 43b on both the first part 41a and the second part 41b of the tag 4. The first part 41a and second part 41b can be identical from a construction point of view, however the content on the displays 43a, 43b may differ.

In FIG. 4a a battery-less variant of the electronic bag tag 4 is shown, wherein the electronics and the first display 43a are located in the first part 41a and the second display 43b is located in the second part 41b. A display cable 45 connects the electronics in the first part 41a with the second part 41b for transmitting the information to be displayed on the second display 43b from the electronics to the second part 41b.

In FIG. 4b a variant of the electronic bag tag 4 is shown that includes a power supply 47. The electronics and the first display 43a are located in the first part 41a and the second display 43b is located in the second part 41b. A power cable 48 connects the power supply 47 with the first part 41a to power the electronics in the first part 41a. A display cable 45 connects the electronics in the first part 41a with the second part 41b for transmitting the information to be displayed on the second display 43b from the electronics to the second part 41b.

In FIG. 4c another variant of the electronic bag tag 4 is shown that includes a power supply 47. The electronics are located at the power supply 47, the first display 43a is located in the first part 41a and the second display 43b is located in the second part 41b. A display cable 45 connects the electronics at the power supply with the first part 41a and the second part 41b for transmitting the information to be displayed on the first display 43a and the second display 43b from the electronics to the first part 41a and the second part 41b, respectively.

The displays 43a and 43b are typically used to display variable information such as e.g. the license plate number, the place and date of issue, the final destination name, the final destination and/or transfer routing in IATA airport, the airline code and/or flight number.

An information area 42a, 42b next to the display 43a, 43b can be used to print non-variable information, such as e.g. the name of the passenger (i.e. the owner of the electronic bag tag), a barcode with the name of the passenger and/or an identification code of the electronic bag tag encoded therein, advertorial information e.g. in the form of an airline logo, and etcetera. Alternatively or additionally the non-variable information can be displayed on the displays 43a and 43b.

The electronic bag tag 4 can have one or more fastening means or punched or drilled holes 44 for attaching the first part 41a and second part 41b to the suitcase 46.

FIG. 6 shows an example of how the electronic bag tag 4 can be integrated in the suitcase 46. FIG. 6 shows a side view of the suitcase 46 in closed position with a handle at the top and the two sides of the suitcase 46 being separated by the vertical line in the middle. The bottom part of the suitcase is not shown.

The electronic bag tag shown in FIG. 6 is a non-battery operated tag such as shown in FIG. 4a. Recesses 49 on the outside of the suitcase 46 hold and contain the two parts 41a and 41b of the electronic bag tag. Although alternatively the two parts 41a and 41b can be attached on the outside of the suitcase 46, i.e. not within a recess, the recesses provide better protection for the displays as in this configuration the outer surface of the suitcase including the displays is substantially flat.

The packaged first part 41a typically includes the first display 43a and all embedded electronic components of the bag tag and can therefore be called the master part of the electronic bag tag.

The packaged second part 41b typically includes the second display 43b only and can therefore be called the slave part of the electronic bag tag.

A linkage 50 can be used to detachably attach and fix the first part 41a and the second part 41b within the recess 49 such that is easy for a person to snap on without the use of tools and easy to take off from the inside of the suitcase 46.

The display cable 45 is typically embedded within the suitcase.

The electronic bag tag shown in FIG. 7 is a battery-operated tag. FIG. 7 differs from FIG. 6 in that a battery 47 is added to the electronic bag tag, such as shown in FIG. 4b. The battery 47 is typically an interchangeable and/or rechargeable battery and enables wireless communication capabilities in the electronic bag tag, such as GSM/GPRS, GPS or other wireless communication capabilities that are connected to the master display part 41a. The antenna assemblies are preferably located at the first part 41a for better reception. The battery 47 can be embedded in the suitcase within a housing on the inside of the suitcase and is connected to the first part 41a via power line 48 and the second part 41b via display cable 45.

The electronics can be integrated with the battery 47, such as shown in FIG. 4c, in which case the power cable 48 is replaced by a display cable 45 in FIG. 7.

By using and integrating two, large enough, thin, flexible or inflexible active matrix displays on both sides of the flexible or inflexible electronic bag tag, the electronic bag tag can be made to display all bag tag data including horizontally and vertically positioned 1D barcodes on both sides of the electronic tag conform IATA specifications as described in the IATA Baggage Services Manual. This makes the electronic bag tag of the invention backward compatible with visual bag tag data and barcode in-line-of-sight scanning technology as used at airports worldwide. An integrated RFID UHF assembly makes it further compatible with the scanning and tracking & tracing technology as used in some airports.

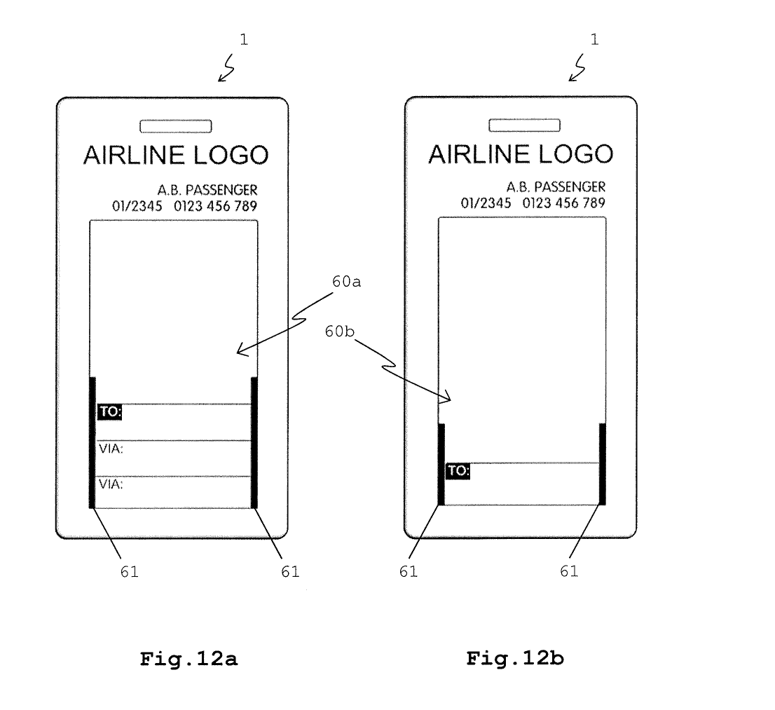

Conform the IATA specifications each display can have two small green bars 61 as shown in FIG. 12a and FIG. 12b, which are printed on top of the display's left and right side using green transparent ink to indicate a so-called “Schengen” baggage label, which can be switched to black by positioning black pixels exactly behind the green bars in order to indicate a regular baggage label.

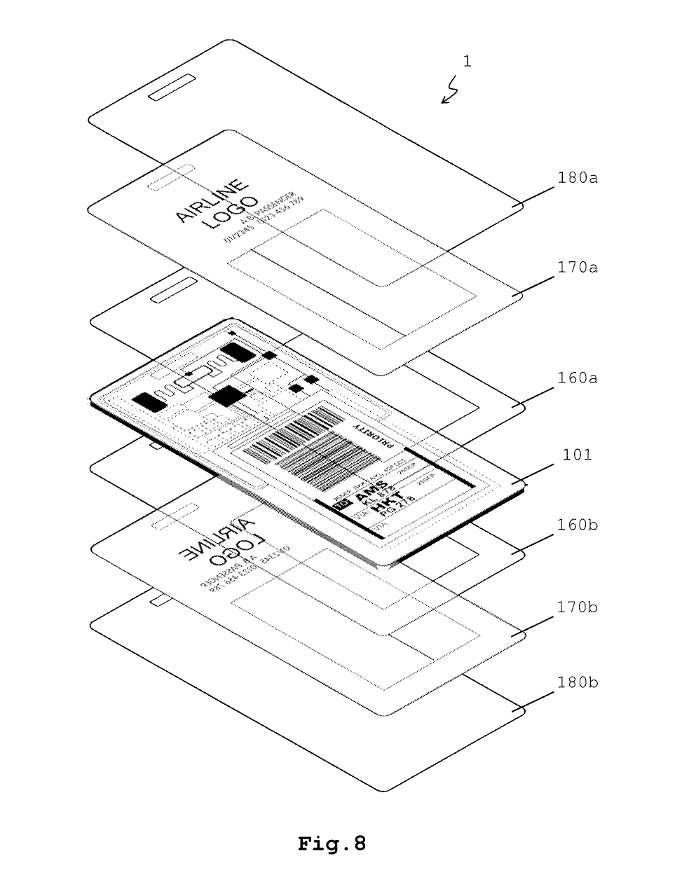

FIG. 8 shows an example of the layers build-up of an inflexible dual display electronic bag tag.

The first layer 180a on the first side of the inflexible electronic bag tag is a laminated or glued transparent polymer based film.

The second layer 170a on the first side of the inflexible electronic bag tag is a laminated pre-printed PVC substrate (or other polymer like polycarbonate (PC), polyphenyl delta-butylene (PdB) or polyester, and etcetera) which may come in any kind of color combination and contain preprinted graphics, logo's, printed barcode, passenger name, credentials and/or other types of branding.

The third layer 160a on the first side of the inflexible electronic bag tag is a MS polymer or polyurethane layer or similar compound.

The inflexible printed circuit board layer 101 has a highly adaptive architecture including electronic components. The displays can have a glass backplane or flexible backplane. The displays can further have a special hardened glass top layer glued on top of the front-plane.

The third layer 160b on the second side of the inflexible electronic bag tag is a MS polymer or polyurethane layer or similar compound.

The second layer 170b on the second side of the inflexible electronic bag tag is a laminated pre-printed PVC substrate (or other polymer like polycarbonate (PC), polyphenyl delta-butylene (PdB) or polyester, and etcetera) which may come in any kind of color combination and contain graphics, logo's, printed barcode, passenger name, credentials and other types of branding.

The first layer 180b on the second side of the inflexible electronic bag tag is laminated or glued transparent polymer based film.

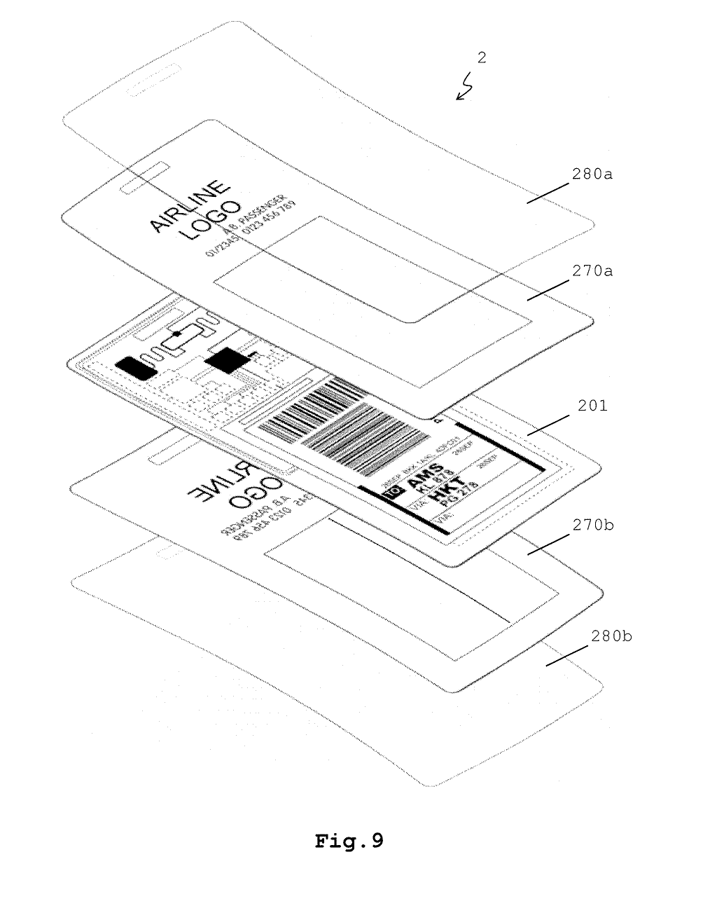

FIG. 9 shows an example of the layers build-up of a flexible dual display electronic bag tag.

The first layer 280a on the first side of the flexible electronic bag tag is a laminated or glued transparent (flexible) polymer based film.

The second layer 270a on the first side of the flexible electronic bag tag is a laminated pre-printed flexible polymer based substrate or PVC substrate (or other polymer like polycarbonate (PC), polyphenyl delta-butylene (PdB) or polyester, and etcetera) which may come in any kind of color combination and contain graphics, logo's, printed barcode, passenger name, credentials and other types of branding.

The flexible thin film printed circuit board layer 201, which is a flexible inlay, has a highly adaptive architecture that includes printed electronic components. For the printed electronics conductive copper, silver ink and/or conductive polymers can be used. A thin film PCB can be made with an electronic circuitry using flexible conductive copper in combination with highly miniaturized integrated chips (integrated circuits) such that it will not jeopardize the flexible integrity of the thin film PCB. The displays have both a flexible front- and backplane.

The second layer 270b on the second side of the flexible electronic bag tag is a laminated pre-printed flexible polymer based substrate or PVC substrate (or other polymer like polycarbonate (PC), polyphenyl delta-butylene (PdB) or polyester, and etcetera) which may come in any kind of color combination and contain graphics, logo's, printed barcode, passenger name, credentials and other types of branding.

The first layer 280b on the second side of the flexible electronic bag tag is a laminated or glued transparent (flexible) polymer based film.

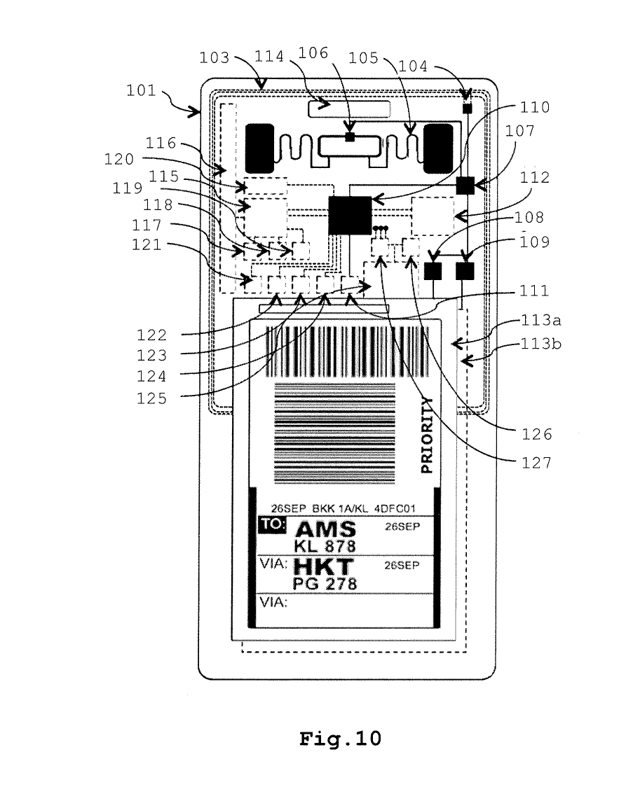

FIG. 10 shows a more detailed view of an inflexible printed circuit board layer 101 of an exemplary embodiment of the invention. FIG. 10 shows a standard debit/credit card form factor that is compliant with ISO/IEC 7810 ID-1. Depending on industry and/or customer requirements this form factor and/or dimensions can be different. ISO/IEC 7810 ID-1 form factor dimensions are approximately 85.70 mm×54 mm×2.3 mm. Although a standard debit/credit card form factor is preferred, the exact dimensions of the inflexible printed circuit board layer 101 may vary in width, height and/or thickness.

It will be understood that the inflexible printed circuit board layer used in the foldable electronic bag tag 3a can be made, with the necessary adjustments, based on the inflexible printed circuit board layer 101 as shown in FIG. 10. The same applies to the first part 41a and second part 41b of the tag 4, in so far these are made inflexible.

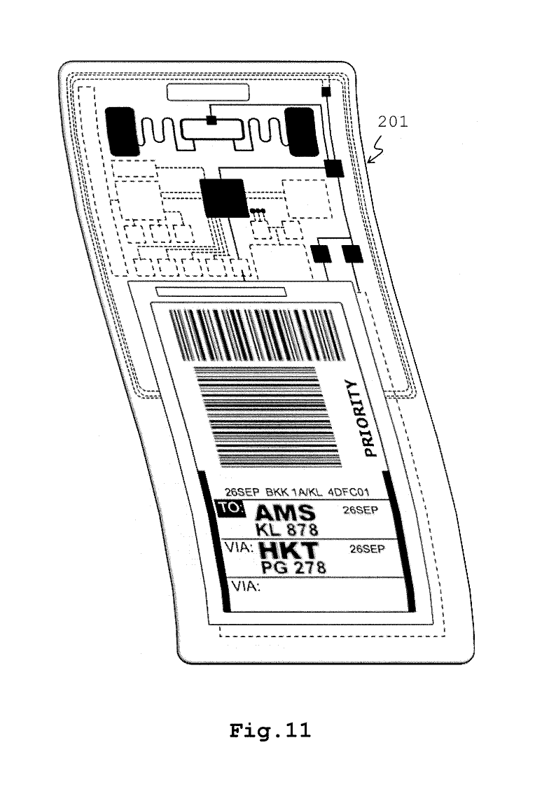

FIG. 11 shows a more detailed view of a flexible printed circuit board layer 201 of an exemplary embodiment of the invention. The form factor and electronic components in FIG. 11 are similar to the electronic components shown in FIG. 10 and therefore not repeated. Alternatively an ISO/IEC 7813 form factor in terms of card thickness is used, being approximately 0.8 mm.

It will be understood that the flexible printed circuit board layer used in the foldable electronic bag tag 3b can be made, with the necessary adjustments, based on the flexible printed circuit board layer 201. The same applies to the first part 41a and second part 41b of the tag 4, in so far these are made flexible.

The following electronic components not requiring a local power supply are shown: RFID HF antenna 103; integrated circuit with HF 13.56 MHz ISO 14443 and/or ISO 15693 support 104; RFID UHF antenna 105; integrated circuit with UHF 860 t/m 960 MHz EPC Gen2 integrated circuit ISO 18000-6C support 106; main power management module 107; optional power management module for the first display depending on display used 108; optional power management module for the second display depending on display used; main tag controller integrated circuit 110; optional security controller integrated circuit 111; first display 113a with integrated display driver integrated circuit; and second display 113b with integrated display driver integrated circuit.

The following optional electronic components requiring a local power supply are shown: GPS receiver integrated circuit or hybrid GNSS integrated circuit 112; GSM/GPRS multi band modem integrated circuit 115; GSM/GRPS/GPS antenna 116; SIM on chip or E-SIM 117; speaker 118; V motor 119; LED light 120; button 121 for on/off switching the transmitting function of GSM/GPRS, GPS, DASH7 or other wireless communication technologies that can cause interference; MEMS motion sensor(s) 122; digital and analog I/O 123 for relays, digital sensors and analog sensors; miscellaneous component 124 such as an additional (non-)volatile memory or another wireless communication technology such as DASH7, Bluetooth Low Energy or Zigbee; power supply 125 in the form of a thin flexible battery, a thin flexible rechargeable battery with or without energy harvesting from ambient light (via a solar cell) and/or movement (via sensors), or a lithium ion rechargeable battery; a power management system 126, and a power management system feeding main tag controller integrated circuit with 5V, 3.3V or 1.8V 127.

Typically, the RFID UHF antenna has a high readability and is orientation insensitive due to symmetry by design. The RFID UHF IC protocol preferably conforms to EPC Class 1 Gen 2, which supports contactless interfaces conform ISO 18000-6C (869 MHz), FCC (915 MHz) and ETSI (865 MHz).

The electronic bag tag can be activated by proximity to an active reader. When the electronic bag tag enters a reader's RF field, the power management converts the induced electromagnetic field to the DC voltage that powers the chip in the tag controller, which can include the integrated dual display controller.

In case the tag main controller has an integrated dual display controller or two separate display controllers, the integrated circuit is typically able to run multiple applications and execute command sequences and overhead duties. The integrated dual display controller or two separate display controllers is/are used for driving the two displays. The electronic bag tag's main controller runs a proprietary operating systems based on open platform technology such as Java, proprietary firmware including driver software for driving displays and other components, proprietary security software and/or proprietary software applications.

The security controller can be used for secure private data storage and/or secure data display. The security controller optionally supports proprietary security algorithms.

In an exemplary embodiment the dual flexible display is a dual flexible active matrix display with the following characteristics. It will be understood that the invention is not limited to this exemplary embodiment. The front and rear display size is 2.7″, but may be larger or smaller. In the front plane a polymer substrate with E-ink technology is used. In the back plane a sheet of glass with active matrix array is used, however a polymer substrate with Active-Matrix array using EPLaR technology or similar can also be used making the display flexible. The total thickness of each display is approximately 1 mm. In case a flexible display is used, the flexibility or bending radius is 20 mm or larger. The resolution is approximately 200 DPI. The display has a wide viewing angle. The gray scale levels can be either 1 bit or 4 bit. Low cost manufacturing of bi-stable flexible displays can be achieved using existing high yielding LCD factory and EPLaR technology. The display ultimately has a low power consumption and an input voltage of approximately 3 Volts. The display comprises flexible connectors.

In an exemplary embodiment the non-volatile memory comprises 32, 128 or 512 bits for user memory, 128 or 496 bits for EPC memory and reserved memory. The data retention is typically 50 years and the cycle endurance is 100.000. Optionally it is possible to implement chipsets with more memory or to extend and/or stack memory.

The system design of the electronic bag tag allows adding additional components such as but not limited to: button(s) for navigation purposes, memory other card/tag controller such as Smart MX, Desfire, and etcetera.

A hole 114 can be punched or drilled in the inflexible printed circuit board layer 101 to enable attaching a baggage strap to the electronic bag tag for attaching the electronic bag tag to a piece of luggage.

The main controller integrated circuit 110 typically contains a proprietary Operating System (OS) and a proprietary software application embedded in the OS layer. The embedded software application receives, converts and processes bag tag data and stores the bag tag data and/or processed bag tag data in the designated non-volatile memory. The processed bag tag data can be formatted such that it can be presented together with a pre-loaded template on both displays. Two examples of pre-loaded templates 60a, 60b are shown in FIG. 12a and FIG. 12b, respectively. The OS can contain the possibility to “post-load” software applications.

For fast transactions, bag tag data sent from a back-end system to the electronic bag tag can be kept to a bare minimum. For this a method can be used whereby a part of the bag tag data, the so-called “license plate” number, is converted on the tag using IATA specified barcode font for 1D barcodes so that no barcode images have to be sent to the tag. The bag tag data format coming from the airline back-end system can be sent in ASCII format and wirelessly transferred to the tag. The ASCII data received by the tag's main controller integrated circuit 110 is then converted using an ASCII converter and then processed by the tag's application and a method that allows sending of only variable bag tag data by using specially designed, “pre-loaded” and stored templates on the tag's main controller integrated circuit's non-volatile memory.

The electronic bag tag can optionally be securely “paired” or “synced” with a smart card with wireless communication capabilities belonging to a certain passenger, to allow a fast and secure baggage check-in/drop-of process and whereby baggage claim information can be sent, stored and displayed on the smart card via the wireless communication interface.

The electronic bag tag can be made as a passive tag, so without a local power supply, by using highly energy efficient displays that only require power when data needs to be refreshed and that do not need power to maintain data on the display. Such displays are known as “bi-stable” and can be found in for instance electrophoretic displays from for example Eink and Sipix.

In a powerless electronic bag tag the energy needed to transfer data to the tag, convert, process and display the bag tag data can be provided by an external RFID HF and/or UHF reader connected to a power source, whereby power inducted by the RF field of the reader is picked up by the tag's RFID HF or UHF antenna to activate the tag's main controller and to perform the data transaction until data is presented on both displays.

The electronic bag tag can also be made as an active dual display enabled RFID UHF tag by embedding a local onboard power supply.

The electronic bag tag can alternatively be made as an active tag to support e.g. other wireless communication components such as DASH7, Bluetooth (Low Energy), GSM/GRPS including an E-SIM (SIM on a chip), GPS or GNSS hybrid, and etcetera, for the purpose of wireless receipt of bag tag data over a longer range and improved indoor and outdoor tracking & tracing of the tag.

The electronic bag tag can include all sorts of (MEMS) sensors such as 3-axis accelerometer, 3-axis magnetic sensor, single dual or tri-axis gyroscope, pressure sensor including altitude, and etcetera.

The main functionalities of the electronic bag tag are: wireless receipt of bag tag data (function 1); processing, storage and displaying of bag tag data (function 2); display of bag tag data and compatibility with conventional airport systems and technology (function 3); and tracking & tracing in airport's baggage systems, indoors in general and outdoors (function 4).

Re function 1 and function 4, the electronic bag tag can wirelessly receive bag tag data using the following HF and UHF RFID frequency bands. The 13.56 MHz (HF) band can be used using the ISO/IEC 14443 interface (includes Near Field Communication) and/or the ISO/IEC 15693 interface. The 860/960 MHz (UHF) band can be used using ISO/IEC 18000-6C, EPC Gen2 for electronic bag tags with segmented electrophoretic displays. UHF is used in several airports in the world and recommend by IATA. A non-battery operated electronic bag tag using these HF and UHF frequencies classifies as a passive tag.

Re function 1 and function 4, the electronic bag tag can be made to wirelessly receive bag tag information using the following UHF RFID frequency band. The 433 MHz (UHF) band can be used using ISO/IEC 18000-7 also known as DASH7. An electronic bag tag using these UHF frequencies requires a battery and classifies as an active tag.

Re function 1 and function 4, the electronic bag tag can be made to wirelessly receive bag tag information using the following alternative frequency bands. The 2450 and 5800 MHz band can be used for 802.11 WLAN, Bluetooth and Zigbee standards. An electronic bag tag using these frequencies requires a battery and classifies as an active tag.

Re function 1 and function 4, the electronic bag tag can be made to wirelessly receive bag tag information using mobile networks. E.g. GSM/GPRS can be used for sending ASCII data (or other data formats) from a back-end system to the electronic bag tag.

Re function 2, the tag is typically operated by an (proprietary) operating system (OS) installed on the electronic bag tag's embedded main controller and by a proprietary application embedded in the OS layer which may contain an ASCII converter, IATA specified barcode font(s) and specially designed pre-loaded templates.

In order to achieve fast wireless transactions, the amount of data that is to be sent to the electronic bag tag is preferably kept to a bare minimum. For this reason no images will be sent to the tag, although possible, but data in ASCII format or any other suitable format is sent to and processed on the electronic bag tag's main controller using an ASCII or other converter. Binary data can be used for bi-directional request/acknowledge and security purposes. 1D barcodes can be generated on the electronic bag tag's main controller by translating the so called “license plate” number derived from the received bag tag data, using barcode font “interleaved 2 of 5” as specified by IATA Baggage Services Manual. Several specially designed templates such as e.g. shown in FIG. 12a and FIG. 12b, which resemble pre-printed paper bag tags, can be pre-loaded and stored on the tag's main controller's non-volatile memory so that only variable bag tag data needs to be sent. Depending on the received bag tag information, the correct template is selected and displayed.

Bag tag data can be stored on the tag's main controller's non-volatile memory, e.g. including bag tag data for the current trip with up to 4 flight segments and bag tag data of up to at least 2 previous trips (up to 8 flight segments).

Re function 3, for backward compatibility purposes the use of embedded active matrix displays are preferred and would be the most cost effective given the amount of data and barcodes that need to be displayed on both sides of the tag. However the electronic bag tag's system architecture can accommodate other types of displays such as segmented displays and passive matrix displays or a combination of.

Using the electronic bag tag's stored templates 60a, 60b, the variable bag tag data and 1D barcodes are then pushed towards the two active matrix displays and presented such that the tag is compliant with IATA specifications for baggage labels as described in IATA's Baggage Services Manual.

Conform the same IATA specifications the tag also needs to be able to function as what's known as a “Schengen” baggage label. To achieve this, each display may have two small green bars 61 printed on top of the display's left and right side using green transparent ink to indicate a so-called “Schengen” baggage label, which can be switched to black by positioning black pixels exactly behind the green bars in order to indicate a regular baggage label.

Re function 1 and function 3, in business critical operational environments such as airport check-in and baggage check-in, the operational efficiencies are gained when devices carried by passengers are non-reliant on batteries. The dual display electronic bag tag is therefore extremely energy efficient and can operate without a local power supply (battery) and still maintain data on both displays. A battery-less electronic bag tag can nonetheless be written to using an external RFID HF reading device as a power supply source. The electronic bag tag's power management module ensures that power derived by the electronic bag tag's embedded RFID HF interface from the RF field of an external RFID HF device, which is usually around 5V, is exactly regulated to the supply voltage required by the tag's main controller and the electronic bag tag's two integrated displays such that the electronic bag tag's main controller can receive and process data and present this data on both its displays. The battery-less operation of the electronic bag tag and the low energy efficient nature of the RFID HF interface requires energy efficient display technologies like electrophoretic, bi-stable displays or displays with similar technology that only require power when data needs to be refreshed on the display.

Re function 1 and function 3, the electronic bag tag's system architecture can accommodate all sorts of other wireless communication capabilities such as DASH7, Bluetooth (Low Energy), GSM/GRPS including an E-SIM (SIM on a chip, also known as U-SIM), UMTS, LTE, CDMA, CDMA2000, GPS or GNSS hybrid, etcetera, for the purpose of wireless receipt (long range) of bag tag data and tracking & tracing of the tag. All of which would require the tag to have an embedded battery or embedded rechargeable battery.

For example, with DASH7 technology embedded in the electronic bag tag, baggage fitted with this tag can be automatically checked-in upon nearing the airport terminal within a range of approximately 1 km enhancing the airport's flow and throughput, and its accurate indoor tracking and tracing capabilities.

Also GSM/GPRS capabilities can be of interest as it would enable baggage check-in at home or wherever there is GSM coverage, gives the airline the ability to remotely access the tag and re-route baggage by sending new bag tag data to the tag, and enables global tracking & tracing of baggage both indoors and outdoors when fitted with GSM/GPRS with or without GPS or hybrid GNSS.

The battery-less electronic bag tag may be used in the following showcase. A passenger performs an on-airport baggage check-in. The passenger is identified via his boarding pass. A Passenger Name Record (PNR) is retrieved from the back-end system. The passenger is asked to put his “hold-luggage” with his RFID-based electronic bag tag fitted on the belt/weight scale. The passenger's baggage is weighed. Bag tag data is retrieved from the back-end system. Bag tag data is sent from the baggage check-in counter to the battery-less electronic bag tag via the RFID HF interface. In the electronic bag tag the bag tag data is processed, the RFID UHF chip is updated and the processed bag tag data is presented on the displays of the electronic bag tag. The passenger's PNR record is updated and a baggage claim tag is produced and provided to the passenger. The passenger's baggage is sent off to the baggage sortation systems for processing toward the correct aircraft on the platform. The passenger proceeds to security check and gate. The passenger's baggage is being processed, scanned and/or tracked in the airport's baggage systems by reading the 1D barcodes from the tag's displays and/or by reading the tag's RFID UHF.

The battery-powered electronic bag tag may be used in the following showcase. A passenger performs an off-airport passenger and baggage check-in from any Internet enabled desktop computer, laptop, tablet or mobile device. The Passenger Name Record (PNR) is retrieved from the back-end system. The passenger checks-in, his seat is assigned, and the number of hold luggage is confirmed or updated. The passenger boarding pass is provided and passenger's bag tag data is wirelessly sent from the back-end system to passenger battery-powered electronic bag tag via the tag's GSM/GPRS interface. The bag tag data is retrieved by, processed and displayed on the electronic bag tag. The passenger proceeds to the airport and towards the dedicated baggage drop-off counter with the electronic bag tag fitted on the luggage. The passenger is identified, hold luggage is put on the belt/scale and bag tag data is read wirelessly from the tag via the RFID HF interface. The baggage is weighed and the PNR record is updated. The passenger's baggage is sent off to the baggage sortation systems for processing toward the correct aircraft on the platform. Passenger proceeds to security check and gate. The passenger's baggage is being processed, scanned and/or tracked in the airport's baggage systems by reading the 1D barcodes from the tag's displays and/or by reading the tag's RFID UHF and/or by locating the bag via GSM/GPRS and/or GPS triangulation.

1. An electronic bag tag that is configured to display bag tag data received from a first external source, the electronic bag tag comprising miniaturized electronics comprising:
a processor configured to process the bag tag data to obtain processed bag tag data;
a wireless communication interface communicatively connected to the processor and configured to receive the bag tag data from the first external source;
a non-volatile memory communicatively connected to the processor and configured to store the bag tag data and/or processed bag tag data;
a first display a second display each configured to display at least a part of the processed bag tag data, and
wherein the non-volatile memory is preconfigured with one or more templates and wherein the processor is configured to select a template from the one or more templates for displaying the at least part of the processed bag tag data on at least one of the first display and the second display using the template.

2. The electronic bag tag according to claim 1, wherein the first display and the second display are bi-stable displays, wherein the communication interface comprises a RFID HF and/or RFID UHF interface and wherein the electronics are powered by a power inducted by a RF field originating from a second external source.

3. The electronic bag tag according to claim 2, wherein the communication interface is further configured to transmit the at least part of the processed bag tag data to a third external source.

4. The electronic bag tag according to claim 1, further comprising a power supply and wherein the electronics are powered by the power supply.

5. The electronic bag tag according to claim 4, wherein the wireless communication interface comprises at least one of a DASH7, Bluetooth, GSM, GPRS UMTS, LTE, CDMA, CDMA2000, GPS or GNSS hybrid communication interface.

6. The electronic bag tag according to claim 1, wherein the electronics further comprises an integrated dual display controller or two separately integrated display controllers for controlling both the first display and the second display.

7. The electronic bag tag according to claim 1, wherein the first display and the second display are positioned on opposite sides of the bag tag and facing opposite directions.

8. The electronic bag tag according to claim 1, wherein the first display and the second display are positioned on the same side of the bag tag, wherein the bag tag is foldable such that the first display and the second display are facing opposite directions when the bag tag is folded.

9. The electronic bag tag according to claim 1, wherein the second display is separated from the electronics and the first display and communicatively connected to the electronics via a display cable.

10. The electronic bag tag according to claim 1, wherein at least one of the first display and the second display is an inflexible active matrix display and the bag tag is inflexible.

11. The electronic bag tag according to claim 1, wherein the first display and the second display are flexible active matrix displays and the bag tag is flexible.

12. The electronic bag tag according to claim 1, further comprising a sensor communicatively connected to the processor, wherein the sensor is at least one of a 3-axis accelerometer, 3-axis magnetic sensor, single-, dual- or tri-axis gyroscope or pressure sensor.

13. The electronic bag tag according to claim 1, wherein the at least part of the processed bag tag data comprises a barcode to be displayed on the first display and on the second display in conformance with IATA specifications.

14. The electronic bag tag according to claim 13, wherein the bag tag data comprises a license plate number in conformance with IATA specifications, wherein the processor is configured to convert the license plate number into the barcode and wherein the processed bag tag data comprises the bar code.

15. The electronic bag tag according to claim 13, wherein the first display and the second display each comprise two bar portions positioned at opposite edges of the display that are switchable between a green color and a black color depending on the bag tag data.

16. (canceled)

17. The electronic bag tag according to claim 1, wherein the electronics further comprising a security controller, and wherein the wireless communication interface is further configured to communicate only upon presenting a matching or paired external smart card which is used to authenticate the owner of the electronic bag tag using the external smart card and the security controller.

18. A method for using an electronic bag tag having a processor configured to process bag tag data, a wireless communication interface communicatively connected to the processor and configured to receive bag tag data from a first external source, a first display and a second display, the method comprising:
receiving bag tag data with the wireless communication interface;
processing the bag tag data with the processor to obtain processed bag tag data, the processor further selecting a template from one or more templates for displaying at least part of the processed bag tag data;
displaying the at least some of the processed bag tag data with the template on the first display and on the second display; and
scanning at least one of the first display and the second display with an external scanner.

19. The method according to claim 18, and further comprising ascertaining a position of the electronic bag tag with an external location device.

20. The electronic bag tag according to claim 9, and further comprising a suitcase, wherein the first display is visibly attached on a first outer side of the suitcase and wherein the second display is visibly attached on a second outer side of the suitcase opposite of the first outer side.

21. The electronic bag tag according to claim 20, wherein the suitcase comprises a first recess on the first outer side to fit the first display and a second recess on the second outer side to fit the second display.

22. The electronic bag tag according to claim 20, wherein the display cable is integrated in the suitcase and wherein the first display and the second display are detachably connected to the suitcase and the display cable.

23. The electronic bag tag according to claim 20, and further comprising a power supply operably connected to at least some of the electronics, the power supply being integrated in a cover of the suitcase or in a housing inside the suitcase.

24. The electronic bag tag according to claim 23, wherein the electronics are separated from the first display and wherein the electronics are integrated with the power supply
